(19) United States
(12) Patent Application Publication
(10) Pub. No.: US 2020/0342518 A1
(43) Pub. Date: Oct. 29, 2020

(54) ITEM RECOGNITION AND PRESENTION WITHIN IMAGES

(71) Applicant: NCR Corporation, Atlanta, GA (US)

(72) Inventors: Chario Bardoquillo Maxilom, Ibabao Cordova (PH); Mary Pauline Rodrigo Cabungcag, Dalaguete (PH); Jorreca Jaca Gerzon, Tisa (PH)

(21) Appl. No.: 16/397,658

(22) Filed: Apr. 29, 2019

(51) Int. Cl. G06Q 30/06; G06K 9/00; G06K 9/62

(52) U.S. Cl. CPC G06Q 30/0639; G06K 9/6256; G06K 9/00201; G06Q 30/0623

(57) ABSTRACT

Various embodiments herein each include at least one of systems methods and software for item recognition and presentation within images. Such images may be captured of products offered for sale within a store of a retailer and provide a view of currently offered items, such as produce, meats, plants, and the like. One method embodiment includes capturing an image of a staging area and products for sale presented therein and processing the image with a product identifying module to obtain data identifying products, product information, and location within the image of products included in the image. This method may then store the image and the obtained data in a location where the image and obtain data can be accessed in response to requests received via a network.

### BACKGROUND INFORMATION

Online shopping has become popular for many products. However, the ease and simplicity of online shopping sometimes includes tradeoffs. These tradeoffs include product substitutions, online product listings not matching the actual product delivered due to errors or product modifications, product freshness of boxed and fresh products such as produce, fish, meats, plants, and the like not matching customer preferences or expectations, and other such tradeoffs. These tradeoffs prevent some customers from shopping at some online retailers or from buying certain product-types from online retailers.

### SUMMARY

Various embodiments herein each include at least one of systems methods and software for item recognition and presentation within images. Such images may be captured of products offered for sale within a store of a retailer and provide a view of currently offered items, such as produce, meats, plants, and the like.

One method embodiment includes capturing an image of a staging area and products for sale presented therein and processing the image with a product identifying module to obtain data identifying products, product information, and location within the image of products included in the image. This method may then store the image and the obtained data in a location where the image and obtain data can be accessed in response to requests received via a network.

Another method embodiment includes capturing an image of products offered for sale located within a store and providing the image to an object recognition service that identifies products located within the image and a location of each identified product within the image. The method then receives from the object recognition service, product identifiers of the identified products and location data identifying the location of each respective product. In some embodiments, this method may then retrieve product information for each identified product from a product database and augment data of the image for each identified product therein with the product identifier, the location data identifying the location of the product in the image, and the retrieved product information. The image may then be stored with the augmented data in a location where the image and obtain data can be accessed in response to requests received via a network.

A further embodiment, in the form of a system, includes a network interface device, a processor, and a memory storing instructions executable by the processor to cause the system to perform data processing activities. The data processing activities of some such embodiments include receiving, via the network interface device, an image of products offered for sale located within a store and submitting the image to an object recognition service that identifies products located within the image and a location of each identified product within the image. Such embodiment may then receive from the object recognition service, product identifiers of the identified products and location data identifying the location of each respective product. In some embodiments, the data processing activities further include retrieving product information for each identified product from a product database and augmenting data of the image for each identified product therein. The augmented data may include the product identifier, the location data identifying the location of the product in the image, and the retrieved product information. The data processing activities of some embodiments may also include storing the image with the augmented data in a location where the image and obtain data can be accessed in response to requests received via a network.

### BRIEF DESCRIPTION OF THE DRAWINGS

FIG. 1 is a logical block diagram of a computing environment, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems methods and software for item recognition and presentation within images. Such images may be captured of products offered for sale within a store of a retailer and provide a view of currently offered items, such as produce, meats, plants, and the like. One of the purposes of such embodiments is to enable online shoppers to preview actual products offered for sale to determine if and what they may wan to purchase. For example, individual consumers have individual preferences and needs with regard to produce. For example, some consumers may have an immediate need for bananas and therefore prefers to purchase yellow bananas instead of green. The various embodiments herein operate to capture images of products in a store, identify produces within the images, augment the images to include data such as data identifying the products in the image and information associated therewith such as pricing, and providing or storing the data-augmented images to enable consumers shopping online to view currently available products in real or near-real time or as the images may otherwise be updated.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

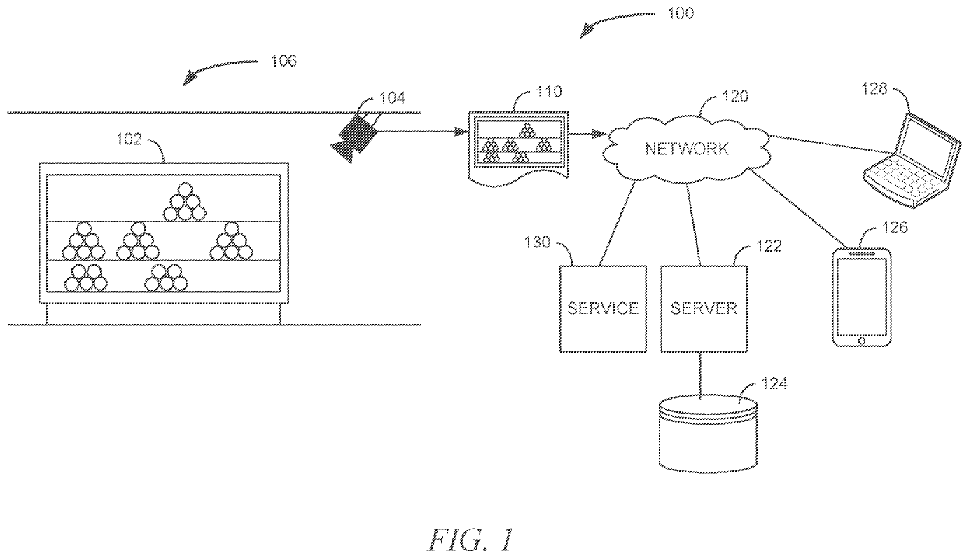

FIG. 1 is a logical block diagram of a computing environment 100, according to an example embodiment. The computing environment 10 includes various environmental and computing elements that are relevant to the various components, products, and data processing activities of the various embodiments herein. The computing environment 100 is therefore offered as a simplified and illustrative example for purposes of explaining different elements that may each be combined in to more or separated into more elements.

The computing environment includes a store area 106 with product presentation areas, such as shelves 102. A view of the shelves 102 is captured by a camera 104 in an image 110. The image 110 may be provided over a network 120 to a process that executes on server 122, to data storage 124, or other network 120 accessible location.

The store area 106 may include a single product presentation area but may instead include many product presentation areas, such as a grocery store that includes many areas where just produce items are presented in addition to other product types such as may be presented at a meat and fish counter, a fresh flower and plan area, and other product types and categories. Thus, in some embodiments there may be a single camera 104 that captures images 110, but other embodiments may include an number of cameras from two to a hundred or even more. The camera 104 may be a camera deployed just for purposes of the various embodiments herein, but may instead be deployed for other purposes as well, such as security monitoring. In some embodiments, the camera 104 is stationary as may be mounted to a ceiling, wall, or even within a display case, which may also be refrigerated. However, in other embodiments, the camera 104 may be human-portable or carried by a remotely controlled device, such as an airborne or rolling drone. The drone of such embodiments may be maneuvered in an automated fashion under command of an automated controller. The camera 104 may be a still image camera or a video camera. In some embodiments, the image 110 is a still image captured by a still image camera. In other embodiments, the image 110 is a frame of a video stream.

As the camera 104 captures images 110, the images 110, in some embodiments, are transmitted over the network 120 to a server 122. The images 110 may be provided on a scheduled basis, periodic basis, upon detection of a change in products on the shelves greater than a threshold which may be fixed or configured, on demand of a requesting customer to view products, and the like in various embodiments. Some embodiments may include a combination of these various image capture frequencies.

The server 122 generally executes one or more processes to process the images 110 to identify products included therein and augment the image data, either in the image data structure itself or in a manner indexed with the image. The data that augments the image may include a product identifier, a location within which the product was identified, and product information such as a product name, description, price, and the like. Products may be identified within images 110 through use of object recognition software packages available for deployment on the server 122 or as may be accessed as services 130 via the network 120, which may include the Internet. Such software and services 130, in some embodiments, use neural networks and models generate from seed images of products to be identified. This may include deep neural networks, such as convolutional neural networks, and the like. Such software and services include the Vision AI product available from Google, Inc., Rekognition available from Amazon, Inc., and other such products. However, in some other embodiments, product identification may be made based on machine recognition of product marking schemes such as barcodes and other such techniques. Some other embodiments may use multiple product recognition techniques.

Once an image 110 has been processed on the server 122 or by a service 130, the image may then be stored in storage 1245 or provided directly to a requestor, such as a web browser or other app or application that executes on a customer's mobile device 126, computer 128, or other computing device.

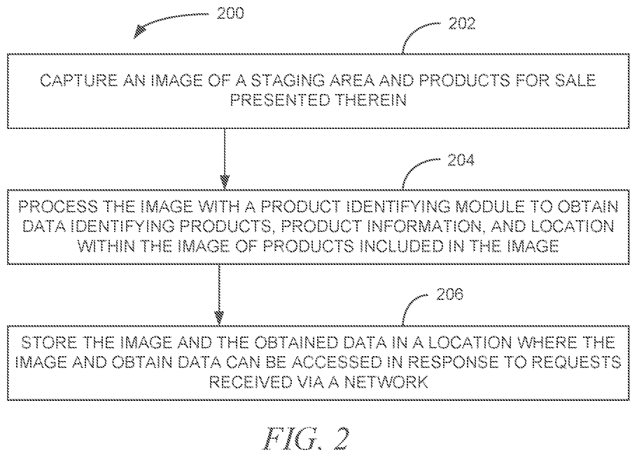

FIG. 2 is a block flow diagram of a method 200, according to an example embodiment. The method 200 is an example of a method that may be performed in whole or in part by the server 122 of FIG. 1 to identify products within an image and to obtain and augment the image with data retrieved based on products identified within the image.

The method 200 includes capturing 202 an image of a staging area and products for sale presented therein and processing 204 the image with a product identifying module to obtain data identifying products, product information, and location within the image of products included in the image. The staging area may be one or more shelves on which products are presented for sale, a refrigerated case, a platform, an area of a show floor, an area of a parking lot, and other physical areas within which products may be presented. The method 200 in some embodiments further includes storing 206 the image and the obtained data in a location where the image and obtain data can be accessed in response to requests received via a network.

In some embodiments, processing 204 the image with the product identifying module includes providing the image to an object recognition service, such as over the Internet, that identifies products located within the image and the location of each identified product within the image. The product identifying module may further include receiving from the object recognition service, product identifiers of the identified products and location data identifying the location of each respective product and retrieving product information for each identified product from a product database. The processing 204 of the image with the product identifying module may also include augmenting data of the image for each identified product therein with the product identifier, the location data identifying the location of the product in the image, and the retrieved product information.

In some such embodiments, augmenting the data of the image includes adding the product identifier, the location data identifying the location of the product in the image, and the retrieved product information as metadata to the image. In some of these and other alternative embodiments, augmenting the data of the image includes adding text to the image that is visible when the image is presented on a display. The text in such embodiments may be added relative to a location of the product in the image and including at least a portion of the retrieve product information. The added text may include one or more of a product name, a price, a saleable unit size, a quantity available, and the like.

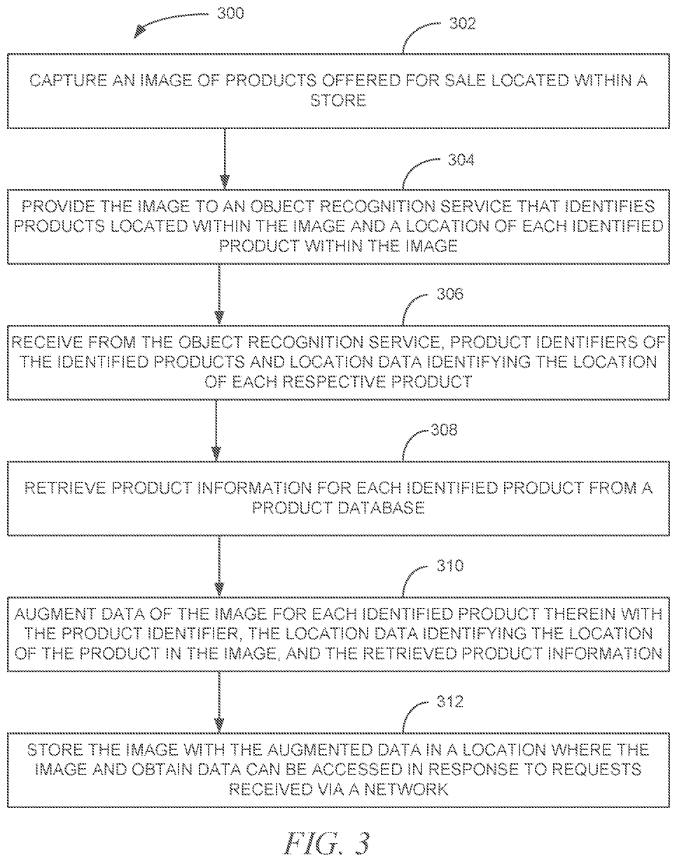

FIG. 3 is a block flow diagram of a method 300, according to an example embodiment. The method 200 is another example of a method that may be performed in whole or in part by the server 122 of FIG. 1 to identify products within an image and to obtain and augment the image with data retrieved based on products identified within the image.

The method 300 includes capturing 302 an image of products offered for sale located within a store and providing 304 the image to an object recognition service that identifies products located within the image and a location of each identified product within the image. The method 300 further includes receiving 306 from the object recognition service, product identifiers of the identified products and location data identifying the location of each respective product. The method 300 may then retrieve 308 product information for each identified product from a product database, either locally or over a network. The retrieved 308 data may then be used to augment 310 data of the image for each identified product therein with one or more of the product identifier, the location data identifying the location of the product in the image, and the retrieved product information. The method 300 may then store 312 the image with the augmented data in a location where the image and obtain data can be accessed in response to requests received via a network.

In some embodiments of the method 300, augmenting 310 the data of the image includes adding text to the image that is visible when the image is presented on a display, the text added relative to a location of the product in the image and including at least a portion of the retrieve product information. The text added to the image may include a price.

In some embodiments of the method 300, capturing 302 the image is performed on a periodic basis and the providing of the image is performed following a comparison to identify the present of a significant change between the captured image and a last captured image that was provided to the object recognition service to identify whether there is a significant change in view of a configuration setting identifying a significance level.

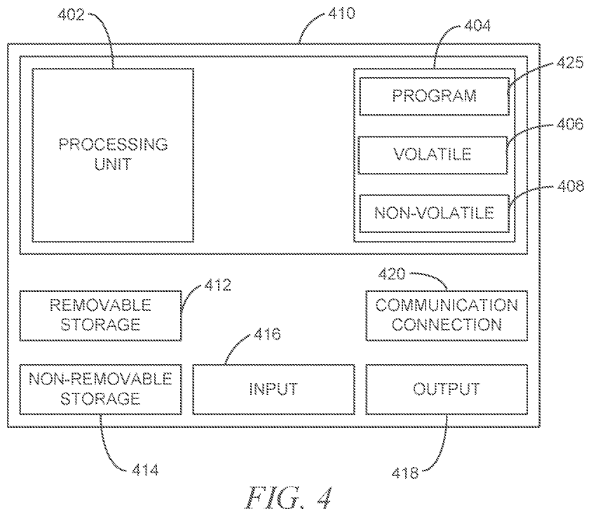

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
capturing an image of a staging area and products for sale presented therein;
processing the image with a product identifying module to obtain data identifying products, product information, and location within the image of products included in the image; and
storing the image and the obtained data in a location where the image and obtain data can be accessed in response to requests received via a network.

2. The method of claim 1, wherein processing the image with the product identifying module includes:
providing the image to an object recognition service that identifies products located within the image and the location of each identified product within the image;
receiving from the object recognition service, product identifiers of the identified products and location data identifying the location of each respective product;
retrieving product information for each identified product from a product database; and
augmenting data of the image for each identified product therein with the product identifier, the location data identifying the location of the product in the image, and the retrieved product information.

3. The method of claim 2, wherein the object recognition service includes a deep neural network object recognition model built and maintained from training images of products to be recognized through use of the model.

4. The method of claim 2, wherein augmenting the data of the image includes adding the product identifier, the location data identifying the location of the product in the image, and the retrieved product information as metadata to the image.

5. The method of claim 2, wherein augmenting the data of the image includes adding text to the image that is visible when the image is presented on a display, the text added relative to a location of the product in the image and including at least a portion of the retrieve product information.

6. The method of claim 5, wherein the text added to the image includes a product name and a price.

7. The method of claim 1, wherein the captured image is a frame of a captured video and the method is performed with regard to a plurality of the frames of the captured video.

8. The method of claim 1, wherein the staging area is a shelf in a grocery store.

9. The method of claim 1, wherein capturing the image includes receiving the image via a network from a stationary imaging device.

10. A method comprising:
capturing an image of products offered for sale located within a store;
providing the image to an object recognition service that identifies products located within the image and a location of each identified product within the image;
receiving from the object recognition service, product identifiers of the identified products and location data identifying the location of each respective product;
retrieving product information for each identified product from a product database;
augmenting data of the image for each identified product therein with the product identifier, the location data identifying the location of the product in the image, and the retrieved product information.
storing the image with the augmented data in a location where the image and obtain data can be accessed in response to requests received via a network.

11. The method of claim 10, the object recognition service includes a convolutional neural network object recognition model built and maintained from training images of products to be recognized through use of the model.

12. The method of claim 10, wherein augmenting the data of the image includes adding the product identifier, the location data identifying the location of the product in the image, and the retrieved product information as metadata to the image.

13. The method of claim 10, wherein augmenting the data of the image includes adding text to the image that is visible when the image is presented on a display, the text added relative to a location of the product in the image and including at least a portion of the retrieve product information.

14. The method of claim 13, wherein the text added to the image includes a price.

15. The method of claim 1, wherein capturing the image is performed on a periodic basis and the providing of the image is performed following a comparison to identify the present of a significant change between the captured image and a last captured image that was provided to the object recognition service to identify whether there is a significant change in view of a configuration setting identifying a significance level.

16. A system comprising:
a network interface device, a processor, and a memory storing instructions executable by the processor to cause the system to perform data processing activities comprising:
receiving, via the network interface device, an image of products offered for sale located within a store;
submitting the image to an object recognition service that identifies products located within the image and a location of each identified product within the image;
receiving from the object recognition service, product identifiers of the identified products and location data identifying the location of each respective product;
retrieving product information for each identified product from a product database;
augmenting data of the image for each identified product therein with the product identifier, the location data identifying the location of the product in the image, and the retrieved product information.
storing the image with the augmented data in a location where the image and obtain data can be accessed in response to requests received via a network.

17. The system of claim 16, wherein storing the image with the augmented data includes transmitting the image with the augmented data via the network interface device to a source of the image.

18. The system of claim 16, wherein the data processing activities are performed on a time-scheduled basis.

19. The system of claim 16, wherein the data processing activity of augmenting the data of the image includes adding the retrieved product information to the image.

20. The method of claim 19, wherein the retrieved product information is added as metadata to the image.
